(19) United States
(12) Patent Application Publication
(10) Pub. No.: US 2011/0139026 A1
(43) Pub. Date: Jun. 16, 2011

(54) INK-JET PLATEMAKING METHOD

(75) Inventors: Hitoshi Moritomo, Tokyo (JP); Hirotaka Iijima, Tokyo (JP); Akio Maeda, Tokyo (JP)

(73) Assignee: KONICA MINOLTA HOLDINGS, INC., Tokyo (JP)

(21) Appl. No.: 13/058,917

(22) PCT Filed: Jun. 9, 2009
(86) PCT No.: PCT/JP2009/060508

§ 371 Date: Feb. 14, 2011

(30) Foreign Application Priority Data
Aug. 19, 2008 (JP) 2008-210492

(51) Int. Cl. B41C 3/08

(52) U.S. Cl. 101/401.1

(57) ABSTRACT

An ink-jet platemaking method is provided which takes advantage of the high convenience and high productivity characteristic of platemaking by ink-jet printing and which mitigates or improves the liquid gathering caused by droplet coalescence and printing durability, which have been problematic in platemaking by ink-jet printing. The ink-jet platemaking method comprises: using an ink for platemaking comprising water, one or more water-soluble organic solvents, and fine resin particles; adhering the ink for platemaking to a heated printing plate material; and volatilizing the solvent contained in the platemaking ink to dry the ink and thereby form an image. The ink-jet platemaking method is characterized in that the fine resin particles have a minimum film-forming temperature (MFT (water)) of 40° C. or higher, the ink for platemaking contains a water-soluble organic solvent (A) which lowers the MFT of the fine resin particles by 5° C. or more, the water-soluble organic solvent (A) accounts for 20% or more of all water-soluble organic solvents contained in the ink, and the water-soluble organic solvent (A) has a boiling point of 180-300° C.

### TECHNICAL FIELD

This invention relates to an ink-jet palate making method, and specifically, this invention relates to an ink-jet plate making method of a computer to plate (CTP) method using an ink-jet recording method.

### BACKGROUND

With increased digitization of printing data, it is demanded a CTP method which is cheap and easy to handle, and which has printing aptitude equivalent to a lithographic printing plate (PS plate). Especially in recent years, there have been proposed various types of CTP method using an infra-red laser recording. Among them, so called dry CTP has been taken attention, which does not need a special development process (including a development on a printing press). However, these methods require extremely high energy for image formation, and an exposure device is also expensive.

On the other hand, there was proposed a method in which an oleophilic image was directly formed on a substrate having a hydrophilic surface with an ink-jet method. This is a CTP method enabling to produce a printing plate without a special development process. This method applied an oil-based ink via an ink-jet recording method on a printing plate material and dried to prepare a printing plate with residual resins corresponding to images (for example, refer to Patent document 1). However, problems have been noted in that printing durability was insufficient and resolution was decreased due to so-called beading before drying of ink droplets having adhered to the surface of the printing plate.

Further, as another methods were disclosed a plate making method such as a solid ink method described in JP-A Nos. 11-139016 and 11-139017, or of UV curing type which forms an image by applying a photo curable ink containing a photo curable monomer on a printing plate material, followed by curing the image by irradiation with light (for example, refer to Patent document 2). However, by using the solid ink method or the UV curing method which solidifies the whole ink of a non-solvent type without an evaporation component, an image formation part will have a swollen structure with respect to the non-image formation part. Therefore, it has the problem of being easy to produce the dot gain phenomenon which transfers even the ink attached to the surrounding of the dots.

### PRIOR ART DOCUMENT

### Patent Document

Patent document 1: JP-A No. 56-62157

Patent document 2: JP-A No. 2007-314632

### SUMMARY OF THE INVENTION

### Problems To Be Solved By the Invention

In view of the above problems, the present invention was achieved. An object of the present invention is to provide an ink-jet plate making method having improved ink gathering caused by coalescence of ink droplets and printing durability which were the problems in the plate making using an ink-jet method, by making use of distinctive features of the convenience and high manufacturing efficiency of an ink-jet method.

### Means to Solve the Problems

The above object of the present invention can be achieved via the following constitutions.
1. An ink-jet plate making method comprising the steps of

using a plate making ink containing at least water, one or more water-soluble organic solvents and resin particles,

adhering the plate making ink on a heated printing plate material, and

volatilizing the solvents in the jetted plate making ink to dry the ink and thereby form an image,

wherein the resin particles exhibit a minimum film-forming temperature in water (MFT (water)) of 40° C. or more, and the plate making ink contains a water-soluble organic solvent (A) which enables to decrease the MFT of the resin particles by 5° C. or more, the water-soluble organic solvent (A) is contained in an amount of 20% or more of all the water-soluble organic solvents in the ink, and the water-soluble organic solvent (A) has a boiling point of 180° C. or more to 300° C. or less.
2. The ink-jet plate making method of the aforesaid item 1, wherein the water-soluble organic solvent (A) is contained in an amount of 80% or more based on the total mass of the water-soluble organic solvents.
3. The ink-jet plate making method of the aforesaid items 1 or 2, wherein the water-soluble organic solvent (A) has a boiling point of 180° C. or more to 250° C. or less.
4. The ink-jet plate making method of any one of the aforesaid items 1 to 3, wherein the water-soluble organic solvent (A) has a boiling point of 180° C. or more to 200° C. or less.
5. The ink-jet plate making method of any one of the aforesaid items 1 to 4, wherein the resin particles have an acid value of 10 mg KOH/g or more.
6. The ink-jet plate making method of any one of the aforesaid items 1 to 5, wherein the resin particles have an acid value of 30 mg KOH/g or more.
7. The ink-jet plate making method of any one of the aforesaid items 1 to 6, wherein the resin particles contain an alkali metal salt as a counter salt of an acid.
8. The ink-jet plate making method of any one of the aforesaid items 1 to 7, wherein the alkali metal salt is a sodium salt.
9. The ink-jet plate making method of any one of the aforesaid items 1 to 8, wherein the plate making ink contains a polymer having a main chain with a plurality of side chains among which cross-linking can be induced by irradiation with actinic energy rays, the polymer is contained in an amount of 0.8 mass % to 5.0 mass % or more based on the total mass of the ink, the main chain of the polymer is a saponified compound of poly vinyl acetate, the degree of saponification is 77% or more to 99% or less, and the degree of polymerization is 200 or more to 4,000 or less.
10. The ink-jet plate making method of the aforesaid item 1, wherein the image is formed by irradiation with actinic energy rays after adhering the plate making ink on the printing plate material.

### Effects of the Invention

According to the present invention, it was possible to provide an ink-jet plate making method having improved ink gathering caused by coalescence of ink droplets and printing durability which were the problems in the plate making using an ink-jet method, by making use of distinctive features of the convenience and high manufacturing efficiency of an ink-jet method.

### BRIEF DESCRIPTION OF DRAWING

FIG. 1 is a drawing showing a flatbed-type ink-jet printer and applicable to an ink-jet plate making method of the present invention.

### EMBODIMENTS TO CARRY OUT THE INVENTION

In the present invention, the mechanism of action is considered as follows in the present stage, although it is under extensive study and there are many still indefinite points. That is, liquid gathering can be improved by heating printing plate material beforehand. This is considered that a water content will evaporate immediately at the time of the depositing of the ink, thereby the viscosity of an ink droplet will be increased. Moreover, in order to achieve excellent printing durability, it becomes important to form a firm coating of resin particles which will be an image portion. For this reason, it is important to perform sufficient heating, as well as to use resin particles with high minimum film forming temperature. Moreover, film formation can be carried out with little energy by the ink incorporating an organic solvent which lowers minimum film forming temperature. Furthermore, it is thought that although this organic solvent will reduce the printing durability at the time of printing to some extent, the organic solvent can be evaporated at the time of plate making by using an organic solvent having a low boiling point to result in keeping membrane strength high.

First, the plate making ink concerning the ink-jet plate making method of the present invention (hereafter it may be called simply an ink) will be described.

The ink concerning the present invention is characterized by the followings: the ink contains at least water, one or more water-soluble organic solvents, and resin particles; the minimum film forming temperature (MFT) in the water of the resin particles is 40° C. or more; and the ink contains a water-soluble organic solvent (A) which lowers the MFT of this resin particulate by 5° C. or more.

### [Minimum Film Forming Temperature]

First, the minimum film forming temperature (hereafter referred to as MFT) of the resin particles will be described.

MFT represents the minimum temperature required for the resin particles to achieve film formation by heating. MET can be easily measured using the minimum-film-forming-temperature measuring apparatus which extends an emulsion (a dispersion of resin particles) on a thermal conductive plate having a temperature gradient and builds a thy film. Moreover, it can be judged whether the solvent in the ink reduces MFT of resin particles by comparing MFT measurement in the state of the aqueous solution of resin particles with MFT measurement in the state of an ink composition. In the present invention, unless existence of an organic solvent is specified, MFT of resin particles indicates in an aqueous solution.

In the present invention, it is judged that the organic solvent reduces MET of resin particles when MFT is lowered by 5° C. or more in consideration of the margin of error in an experiment.

In addition, the water-soluble organic solvent which lowers MFT of resin particles is called a water-soluble organic solvent (A) in the present invention.

### [Resin Particles]

Hereafter, resin particles used for the present invention will be described.

The resin particles according to the present invention are not specifically limited as long as their MET in water is 40° C. or more. Preferable resin particles are composed of polyurethane, polystyrene-acryl, polystyrene-butadiene, polystyrene-maleic acid, polyester, polyether, polycarbonate, polyamide, polyacrylonitrile, polystyrene, polybutadiene, polyacrylic acid, polymethacrylic acid, polyvinyl chloride, polyvinylidene chloride, polyvinyl acetate, acrylic-modified silicone resin, or acrylic-modified fluororesin, as well as a copolymer or a salt thereof. Of these, preferable resin particles are composed of least one type of copolymer selected from polyurethane, polystyrene-acrylic, polystyrene-butadiene, and polystyrene-maleic acid copolymers.

In the ink for plate making of the present invention, the average particle diameter of the resin particles is preferably 5 nm or more to 150 nm or less. When the average particle diameter of the resin particles is 5 nm or more, the effect of improving ink receptivity can be achieved. When the particle diameter is 150 nm or less, stability of ejection from the ink-jet head can be maintained. Thereby, there are realized fine line reproducibility and small character reproducibility in producing a printing plate which is required enhanced deposition accuracy. The average particle diameter of the resin particles of the present invention can be determined using a commercially available particle diameter measuring instrument employing a light scattering method, an electrophoretic method, or a laser Doppler method.

Further, in the ink for plate making of the present invention, the content of the resin particles of the present invention is preferably 0.1 mass % to 7 mass %, more preferably to 5 mass % or less based on the total mass of the ink. When the content of the resin particles is 0.1 mass % or more, an excellent effect on ink receptivity is obtained. When it is 7 mass % or less, adequate ink receptivity can be realized, and also nozzle clogging, resulting from the resin particles, during intermittent ejection can be prevented. Furthermore, viscosity of the ink is usually increased as resin particles are added. With such an increase of the ink viscosity, ejection cannot be realized at a relatively high drive frequency, resulting in decreased productivity. Therefore, additionally, considering the ink viscosity, the added amount is preferably at most 5 mass %.

The resin particle of the present invention may be either a forced emulsification type wherein emulsifying is forcibly carried out using an emulsifying agent, or a self-emulsification type wherein a resin added with a hydrophilic group or hydrophilic segment is dispersed. As the emulsifying agent, a surfactant is frequently used. It is also preferable to use a polymer having a hydrophilic group such as a sulfonic acid group or a carboxylic acid group (for example, a hydrophilic group graft-bonded polymer and a polymer composed of a monomer having a hydrophilic portion and a monomer having a hydrophobic portion).

Recently, as latex polymer particles, in addition to latexes wherein polymer particles with entire particle uniformity are dispersed, there exist latexes wherein polymer particles of a core-shell type with different compositions in the center portion and the outer portion of the particles are dispersed. Latexes of such a type are also preferably used.

### (Acid Value)

An acid value of the resin particles concerning the present invention is preferably 10 mg KOH/g or more, it is more preferably 30 mg KOH/g or more. It is preferably nonionic or anionic from the viewpoint of storage stability.

Although an acid value as used in the present invention generally shows an amount of potassium hydroxide expressed in mg required to neutralize a free fatty acid in 1 g of a sample, as an acid value in the present invention, it can also he determined by calculation from the amount of carboxyl groups which was used as a raw material monomer for synthesis of resin particles and can be neutralized.

### (Alkali Metal)

As a counter salt of an acid contained in the resin particles of the present invention, an alkali metal is preferable. An alkali metal is indicated to lithium, sodium, potassium, rubidium, and cesium, and all of them can exist as a monovalent cation ion in an aqueous solution. In the present invention, sodium, potassium and lithium, are preferably used, and sodium is especially preferable.

An added amount of an alkali metal in the ink is preferably 0.1% to 0.2%.

### [Water-Soluble Solvents]

It will be described a water-soluble organic solvent of the present invention and a water-soluble organic solvent (A) which decreases MFT of the resin particles defined in the present invention by 5° C. or more

Solvents constituting the ink of the present invention contain at least water, and further contain a water-soluble organic solvent.

Examples of the water-soluble solvent applicable to the ink of the present invention include alcohols (e.g., methanol, ethanol, propanol, isopropanol, butanol, isobutanol, sec-butanol, and tert-butanol), polyhydric alcohols (e.g., ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thiodiglycol), polyhydric alcohol ethers (e.g., ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, ethylene glycol monomethyl ether acetate, triethylene glycol monomethyl ether, triethylene glycol monoethyl ether, triethylene glycol monobutyl ether, ethylene glycol monophenyl ether, and propylene glycol monophenyl ether), amines (e.g., ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamethyldiethylenetriamine, and tetramethylpropylenediamine), amides (e.g., formamide, N,N-dimethylformamide, and N,N-dimethylacetamide), heterocycles (e.g., 2-pyrrolidone, N-methyl-2-pyrrolidone, cyclohexyl pyrrolidone, 2-oxazolidone, and 1,3-dimethyl-2-imidazolidinone), and sulfoxides (e.g., dimethylsulfoxide).

The ink concerning the present invention is characterized by containing a water-soluble organic solvent (A) by which MFT of resin particles is reduced by 5° C. or more.

Although a water-soluble organic solvent (A) which lowers MFT of the resin particles contained in the ink by 5° C. or more cannot be determined uniquely since it changes with combination with the resin particles used, it can be easily judged, in combination with the resin, whether a certain water-soluble organic solvent is a water-soluble organic solvent (A) of the present invention or not by using the MFT measuring apparatus as mentioned above.

The water-soluble organic solvent (A) of the present invention is characterized in that it is contained in an amount of 20 mass % or more based on the total mass of the water-soluble organic solvents in the ink, and further, it is characterized in that the water-soluble organic solvent (A) has a boiling point of 180° C. or more to 300° C. or less.

Typical examples of the water-soluble organic solvent (A) which lowers MFT of the resin particles concerning the present invention by 5° C. or more, and the non-lowering water-soluble organic solvent which does not affect on MFT of the resin particles are shown in the following Table 1. In addition, it cannot generally be determined by the type of resin particles whether it has the reducing ability to MFT of the resin particles. The classifications of the solvents in Table 1 are only to show an example, and the present invention is not limited to these illustrated solvents.

TABLE 1

| Boiling | MFT lowering solvent | | MFT non-lowering solvent | |
|---|---|---|---|---|
| point | Boiling | | Boiling | |
| range | point | Name of solvent | point | Name of solvent |
| >250 | 287 | Triethylene glycol | 290 | Glycerin |
| 250-200 | 245 | 2-Pyrrolidinone | 229 | 1,4-Butanediol |
| | 232 | Dipropylene glycol | | |
| 180-200 | 189 | Dimethyl sulfoxide | 197 | Ethylene glycol |
| | 187 | Propylene glycol | | |

The water-soluble organic solvent (A) is preferably contained in an amount of 80 mass % or more based on the total mass of the water-soluble organic solvents in the ink. The boiling point of the water-soluble organic solvent (A) is preferably 180° C. or more to 250° C. or less, and more preferably it is 180° C. or more to 200° C. or less.

A total amount of the solvents (a mixture of water and water-soluble organic solvents) in the ink of the present invention is preferably 50 mass % or more to 98 mass % or less based on the total mass of the ink, and more preferably it is 80 mass % or more to 98 mass % or less. Further, it is preferable that a content of water is 50 mass % or more to 80 mass % or less based on the total mass of the ink.

### [Actinic Energy Ray Curable Polymer]

An actinic energy ray curable polymer preferably used in the present invention will be described.

In the ink according to the present invention, it is preferable that it contains a polymer as an actinic energy ray curable polymer having a main chain with a plurality of side chains among which cross-linking can be induced by irradiation with actinic energy rays. The amount of the polymer is preferably 0.8 mass % or more to 5.0 mass % or less based on the total mass of the ink, the main chain of the polymer is preferably a saponified compound of poly vinyl acetate, the degree of saponification is preferably 77% or more to 99% or less, and the degree of polymerization is preferably 200 or more to 4,000 or less.

Example of a polymer of the present invention having a main chain with a plurality of side chains among which cross-linking can be induced by irradiation with actinic energy rays include those introduced a modification group of a photodimerization type, photodecomposition type, photopolymerization type, photomodification type, or photodepolymerization type into side chains of at least one type of resin selected from the group including a saponified compound of polyvinyl acetate, polyvinyl acetal, polyethylene oxide, polyalkylene oxide, polyvinyl pyrrolidone, polyacrylamide, polyacrylic acid, hydroxyethyl cellulose, methyl cellulose, hydroxypropyl cellulose, or a derivative of any of the above resins, and a copolymer thereof. Of these, a photopolymerization type cross-linkable group is preferable from the viewpoint of performance of images formed.

In the main chain, in view of simplicity and handling with respect to introduction into side chains, a saponified compound of polyvinyl acetate is preferable. The polymerization degree of the actinic energy ray curable polymer is preferably 200 or more to 4,000 or less, and it is more preferably 200 or more to 2,000 or less from the viewpoint of handling. The modification rate of the side chains is preferably 0.3 mol % or more to 4 mol % or less based on the main chain, but more preferably 0.8 mol % or more to 4 mol % or less from the viewpoint of reactivity. When the modification rate of the side chains is less than 0.3 mol % based on the main chain, cross-linking performance is insufficient, resulting in producing small effects of the present invention. In contrast, in the case of larger than 4 mol %, cross-linking density tends to be excessively increased, whereby cross-linking density will be too large and the produced film become hard and fragile, and film strength will be decreased.

As a photodimerization type modification group, preferable are those introduced with a diazo group, cinnamoyl group, stilbazolinium group, or styrylquinolinium group. There are listed the photosensitive resins (compositions) described, for example, in patent publications such as JP-A No. 60-129742.

The photosensitive resin described in JP-A No. 60-129742 is a compound, represented by the following Formula (1), wherein a stilbazolinium group is introduced into a polyvinyl alcohol structural body.

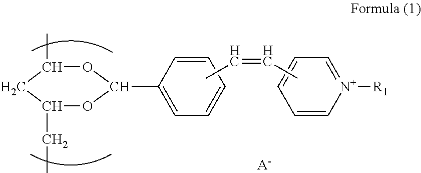

In Formula (1), R₁ represents an alkyl group having 1 to 4 carbon atoms and A⁻ represents a counter anion.

The photosensitive resin described in JP-A No. 56-67309 is a resin composition having a 2-azido-5-nitrophenylcarbonyloxyethylene structure represented by the following Formula (2) or a 4-azido-3-nitrophenylcarbonyloxyethylene structure represented by the following Formula (3) in its polyvinyl alcohol structural body.

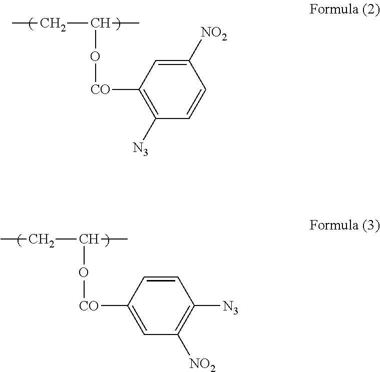

Further, the modification group represented by the following Formula (4) is preferably used.

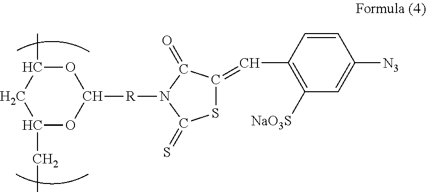

In Formula (4), R represents an alkylene group or an aromatic ring, but a benzene ring is preferable.

As a photopolymerization type modification group, the resin represented by the following Formula (5), as disclosed, for example, in JP-A Nos. 2000-181062 and 2004-189841 is preferable from the viewpoint of reactivity.

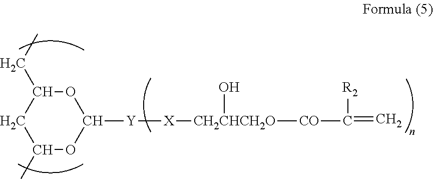

In Formula (5), R₂ represents a methyl group or a hydrogen atom; n represents 1 or 2; X represents —(CH₂)ₘ—COO— or —O—; Y represents an aromatic ring or a single bonding unit; and m represents an integer of 0 to 6.

The photopolymerization type modification group represented by the following Formula (6), as described in JP-A No. 2004-161942, is also preferably used for a water-soluble resin conventionally known in the art.

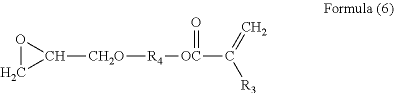

In Formula (6), R₃ represents a methyl group or a hydrogen atom, and R₄ represents a straight-chained or branched alkylene group having 2 to 10 carbon atoms.

Such an actinic energy ray radiation cross-linking type resin is, as one of its features, contained in the range of 0.8 mass % or more to 5.0 mass % or less based on the total ink mass. When the resin exists at 0.8 mass % or more, cross-linking efficiency is enhanced, and then beading and color bleeding become further favorable via a rapid increase in ink viscosity after cross-linking. In the case of at most 5.0 mass %, physical properties of the ink and the state within the ink head are barely affected adversely, resulting in preferable ejection performance and ink storage stability.

In an actinic energy ray radiation cross-linking type polymer according to the present invention, the main chain, which has a polymerization degree to some extent on its own, is cross-linked via cross-linking among side chains. Accordingly, a molecular increasing effect per photon is extremely large, compared to that of an actinic energy ray radiation curing type resin, which is polymerized via common chain reaction. In contrast, in an actinic energy ray radiation curing type polymer conventionally known in the art, the number of cross-linking points is uncontrollable. Therefore, physical properties of a film after cured are uncontrollable, whereby a hard and fragile film tends to result.

In a resin used for the present invention, the number of cross-linking points is totally controllable via adjustment of the length of the main chain and the introducing amount into side chains. Thereby, it is possible to control physical properties of the ink film for different purposes.

Further, since nearly the entire amount of an actinic energy ray radiation curing type ink, other than a colorant, is occupied by a curable component, ink dots after curing are raised, resulting in a thickened plate which tends to cause dot gain. In contrast, in a plate making method using an ink employing a resin used for the present invention, the amount of the resin added is relatively small and the amount of dry components is relatively large, whereby no unnecessarily raised dots are generated after curing, resulting in formation of a printing plate exhibiting excellent final print quality.

### [Photopolymerization Initiators and Sensitizing Agents]

In the present invention, a photopolymerization initiator and a sensitizing agent are also preferably added. These compounds may be dissolved or dispersed in a solvent, or chemically bonded to a photosensitive resin.

Any of such a photopolymerization initiator and a sensitizing agent is applicable with no specific limitation, and those conventionally known in the art can be used.

Although any photopolymerization initiator and sensitizing agent is applicable with no specific limitation, a water-soluble compound is preferable from the viewpoint of mixing properties and reaction efficiency. Especially, 4-(2-hydroxyethoxy)phenyl-(2-hydroxy-2-propyl)ketone (HMPK), thioxythanthone ammonium salt (QTX), and benzophenone ammonium salt (ABQ) are preferable from the viewpoint of properties of mixing with a water-based solvent.

Further, from the viewpoint of compatibility with a resin, more preferable are 4-(2-hydroxyethoxy)phenyl-(2-hydroxy-2-propyl)ketone (n=1, HMPK) and also its ethylene oxide adducts (n=2-5), represented by the following Formula (7).

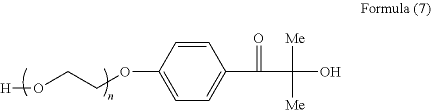

wherein n represents an integer of 1 to 5.

In addition thereto, there are preferably used, for example, benzophenones such as benzophenone, hydroxybenzophenone, bis-N,N-dimethylaminobenzophenone, bis-N,N-diethylaminobenzophenone, or 4-methoxy-4′-dimethylaminobenzophenone; thioxanthones such as thioxthantone, 2,4-diethylthioxthantone, isopropylthioxthantone, chlorothioxthantone, or isopropoxychlorothioxthantone; anthraquinones such as ethylanthraquinone, benzanthraquinone, aminoanthraquinone, or chloroanthraquinone; aeetophenones; benzoin ethers such as benzoin methyl ether; 2,4,6-trihalomethyltriazines; 1-hydroxycyclohexyl phenyl ketone; 2,4,5-triarylimidazole dimmers such as a 2-(o-chlorophenyl)-4,5-diphenylimidazole dimer, 2-(o-chlorophenyl)-4,5-di(m-methoxyphenyl)imidazole dimmer, 2-(o-fluorophenyl)-4,5-diphenylimidazole dimer, 2-(o-methoxyphenyl)-4,5-diphenyimidazole dimer, 2-(p-methoxyphenyl)-4,5-diphenyimidazole dimer, 2-di(p-methoxyphenyl)-5-phenyimidazole dimer, or 2-(2,4-dimethoxyphenyl)-4,5-diphenyimidazole dimer; benzyldimethy ketal; 2-benzyl-2-dimethylamino-1-(4-morphorinophenyl)-butane-1-one; 2-methyl-1-[4-(methylthio)phenyl]-2-morphorino-1-propanone; 2-hydroxy-2-methyl-1-phenyl-propane-1-one; 1-[4-(2-hydroxyethoxy)-phenyl]-2-hydroxy-2-methyl-1-propane-1-one; phenanthrenquinone; 9,10-phenanthrenequinone; benzoins such as methylbenzoin or ethylbenzoin; acrydine derivatives such as 9-phenylacrydine or 1,7-bis(9,9′-acrydinyl)heptane; bisacylphosphine oxide; and mixtures thereof. These may be used individually or in combination.

In addition to these photopolymerization initiators, substances such as an accelerator may be added. Examples thereof include p-dimethylamino ethyl benzoate, p-dimethylamino isoamyl benzoate, ethanolamine, diethanolamine, and triethanolamine. In any of these photopolymerization initiators, the main chain is also preferably grafted to side chains.

### [Colorants]

A plate making ink used for the plate making method of the present invention may be a clear ink containing no colorants, however, being preferably a colored ink containing colorants in order to easily identify patterns drawn on a printing plate.

The content of the colorants may be smaller than that of an ink-jet ink used for image formation, being preferably 0.1 mass % or more to 3 mass % or less based on the total ink mass. The type of the colorants may be either a dye or a pigment.

### (Dyes)

Dyes usable for the present invention are not specifically limited, including water-soluble dyes and dispersion dyes such as acidic dyes, direct dyes, or reactive dyes.

Specific examples of such dyes applicable to the ink of the present invention will now be listed. However, the present invention is not limited only to these exemplified dyes.

### <Water-Soluble Dyes>

Water-soluble dyes usable for the present invention include, for example, azo dyes, methine dyes, azomethine dyes, xanthene dyes, quinone dyes, phthalocyanine dyes, triphenylmethane dyes, and diphenylmethane dyes.

Further, as such dyes, the compound represented by the following Formula (8) or the compound represented by the following Formula (9) can also be used.

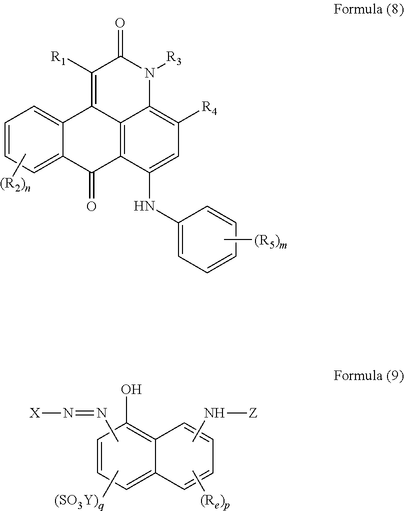

In Formula (8), R₁ represents a hydrogen atom or a substitutable substituent, being preferably a hydrogen atom or a phenyl carbonyl group; R₂, which may differ, represents a hydrogen atom or a substitutable substituent, being preferably a hydrogen atom; R₃ represents a hydrogen atom or a substitutable substituent, being preferably a hydrogen atom or an alkyl group; R₄ represents a hydrogen atom or a substitutable substituent, being preferably a hydrogen atom or an aryloxy group; R₅, which may differ, represents a hydrogen atom or a substitutable substituent, being preferably a sulfonic acid group; n represents an integer of 1 to 4; and m represents an integer of 1 to 5.

In Formula (9), X represents a phenyl group or a naphthyl group, which may be substituted with a substitutable substituent, being preferably substituted with a sulfonic acid group or a carboxyl group; Y represents a hydrogen ion, a sodium ion, a potassium ion, a lithium ion, an ammonium ion, or an alkyl ammonium ion; R₆, which may differ, represents a hydrogen atom or a substituent with which the naphthalene ring can be substituted; q represents 1 or 2 and p represents an integer of 1 to 4, provided that p+q=5; and Z represents a substitutable group, specifically representing a carbonyl group, a sulfonyl group or the group represented by the following Formula (10), and of these, the group represented by following Formula (10) is specifically preferable.

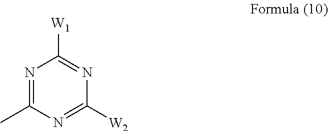

In Formula (10), W₁ and W₂, which each may differ, represent a halogen atom, a hydroxyl group, an alkylamino group, or an arylamino group. Of these, a halogen atom, a hydroxyl group, or an alkylamino group is preferable.

### <Dispersion Dyes>

As dispersion dyes, there can be used dispersion dyes such as azo dispersion dyes, quinone dispersion dyes, anthraquinone dispersion dyes, or quinophthalone dispersion dyes.

### (Pigments)

As pigments usable for the present invention, conventionally known ones can be used with no specific limitation. Both water dispersible pigments and solvent dispersible pigments can be used. Organic pigments such as insoluble pigments or lake pigments and inorganic pigments such as carbon black can preferably be used. These pigments are allowed to exist in the state of being dispersed in the ink. Methods for such dispersion may be any one of self dispersion, dispersion using a surfactant, polymer dispersion, and micro-capsule dispersion.

The insoluble pigments are not specifically limited. Preferable are, for example, azo, azomethine, methine, diphenylmethane, triphenylmethane, quinacridone, anthraquinone, perylene, indigo, quinophthalone, isoindolinone, isoindoline, azine, oxazine, thiazin, dioxazine, thiazole, phthalocyanine and diketopyrrolopyrrole.

Specific pigments to be preferably used include the following ones.

Magenta or red pigments include, for example, C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 166, C. I. Pigment Red 177, C. I. Pigment Red 178, C. I. Pigment Red 202, C. I. Pigment Red 222, and C. I. Pigment Violet 19.

Orange or yellow pigments include, for example, C. I. Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 15:3, C. I. Pigment Yellow 17, C. I. Pigment Yellow 74, C. I. Pigment Yellow 93, C. I. Pigment Yellow 128, C. I. Pigment Yellow 94, and C. I. Pigment Yellow 138.

Green or cyan pigments include, for example, C. I. Pigment Blue 15, C. I. Pigment Blue 15:2, C. I. Pigment Blue 15:3, C. I. Pigment Blue 16, C. I. Pigment Blue 60, and C. I. Pigment Green 7.

Further, black pigments include, for example, C. I. Pigment Black 1, C. I. Pigment Black 6, and C. I. Pigment Black 7.

The average particle diameter of a dispersed pigment contained in the ink of the present invention is preferably 50 nm or more and less than 200 nm.

The particle diameter of a pigment dispersion can be determined using a commercially available particle diameter measuring instrument employing a dynamic light scattering method or an electrophoretic method. Determination via the dynamic light scattering method is frequently employed due to ease and convenience, and excellent accuracy in this particle diameter range.

Pigments used for the ink of the present invention are preferably used via dispersion together with a dispersant and an appropriate additive, according to intended purposes, using a homogenizer. As the homogenizer, a ball mill, sand mill, line mill, or high pressure homogenizer conventionally known in the art can be used. Of these, it is preferable to produce an ink via dispersion using a sand mill, since particle distribution of the ink is narrow. Further, a material for beads used in this sand mill dispersion are preferably zirconia or zircon in view of contamination of bead fragments and ion components. The diameter of such beads is preferably 0.3 mm to 3 mm.

When a pigment to be contained in the ink of the present invention is dispersed, a surfactant and a polymer dispersant can be used as the above dispersant individually or in combination.

### [Surfactants]

The ink of the present invention may contain surfactants.

The surfactants preferably applicable to the ink of the present invention include anionic surfactants such as alkyl sulfuric acid salts, alkyl ester sulfuric aid salts, dialkylsulfosuccinic acid salts, alkylnaphthalene sulfonic acid salts, alkyl phosphoric acid salts, polyoxyalkylene alkyl ether phosphoric acid salts, or fatty acid salts; nonionic surfactants such as polyoxyethylene alkyl ethers, polyoxyalkylene alkylphenyl ethers, acetylene glycols, or polyoxyethylene-polyoxypropylene block copolymers; surfactants such as glycerin esters, sorbitan esters, polyoxyethylene fatty acid amides, or amine oxides; and cationic surfactants such as alkyl amine salts or quaternary ammonium salts.

These surfactants may be use as a dispersant for a pigment. Anionic and nonionic surfactants can specifically preferably be employed.

### [Various Additives]

In the present invention, other additives conventionally known in the art may be contained, including, for example, fluorescent brighteners, antifoamers, lubricants, preservatives, thickeners, antistatic agents, matting agents, water-soluble polyvalent metal salts, acids and bases, pH adjusters such as buffer solutions, antioxidants, surface tension adjusters, specific resistance regulators, anti-corrosion agents, and inorganic pigments.

### [Physical Property Values of Ink]

The ink of the present invention is used to stably produce high precision printing plates via an ink-jet method. Accordingly, there exists a preferable range of physical property values of the ink.

The viscosity of the ink is preferably 1 mPa·s or more to 15 mPa·s or less, specifically preferably 2 mPa·s or more to 8 mPa·s or less. When the viscosity is 1 mPa·s or less, stable ejection cannot be realized. When the viscosity is 15 mPa·s or more, satellite occurrence cannot be prevented which is a problem for a printing plate and the ink cannot be ejected at short repetition intervals, resulting in decreased production speed.

The surface tension of the ink is preferably 25 mN/m or more to 50 mN/m or less, specifically preferably 30 mN/m or more to 45 mN/m or less. In the case of 25 mN/m or less, wet spreading of dots having been deposited on a printing plate will be large, resulting in decrease resolution. In the case of 50 mN/m or more, bubbles within the ink-jet recording head cannot be thoroughly escaped, whereby ejection stability will be deteriorated.

### [Production Method of Ink]

The ink of the present invention can be produced via a conventionally known method. In the production process, filtration is preferably carried out. The filtration method is performed, for example, using a metal mesh filter. Further, in combination therewith, using a volume filtration filter made of a resin such as polypropylene, filtration is preferably performed.

Further, the ink of the present invention is preferably degassed. The degassing method includes, for example, a method of degassing by stirring in a vacuum chamber, a method of degassing by sealing after heating the ink, and a method using a degassing module employing hollow fiber. Of these, the method using a degassing module is specifically preferable.

### [Printing Plate Materials]

In printing plate materials used for the plate making method of the present invention, the surface thereof is preferably hydrophilic. As a support used for a printing plate material, any of conventionally known plate materials used for a planographic printing plate can be used with no limitation. There are listed, for example, paper, paper laminated with a plastic (e.g., polyethylene or polypropylene), a metal plate (e.g., aluminum), a plastic film (e.g., cellulose triacetate, cellulose butyrate, cellulose nitrate, polyethylene terephthalate, or polyethylene naphthalate).

Of these, a specifically preferable support includes paper, a polyester film, polyethylene terephthalate, and aluminum plate.

To provide hydrophilic properties on any of such supports, it is preferable to carry out physical treatment such as plasma treatment or corona discharging, or chemical treatment such as coating of a hydrophilic resin or immersion in a surfactant solution individually or in combination. Further, a roughened surface is preferable to easily apply dampening water thereon. The surface roughening method includes a method wherein organic or inorganic particles are allowed to adhere to the surface via coating to provide microroughness by the resulting network structure. Mother preferable example includes those wherein a waterproof hydrophilic layer is provided on any appropriate support as the surface layer. Such a surface layer includes, for example, the layers composed of an inorganic pigment and a binder described in U.S. Pat. No. 3,055,295 and JP-A No. 56-13168; the hydrophilic swollen layers described in JP-A No. 9-80744; and the sol-gel layers composed of titanium oxide, polyvinyl alcohol, and silicic acid described in Japanese Translation of PCT International Application Publication No. 8-507727.

Further, when an aluminum plate, which has widely been employed as a printing plate material, is used, it is preferable to carry out surface roughening treatment; immersion treatment into an aqueous solution of sodium silicate, fluorinated potassium zirconate, or a phosphoric acid salt; or surface treatment such as anodization treatment.

Roughening of the surface of an aluminum plate is carried out via various methods, including, for example, a method of mechanically roughening the surface, a method of electrochemically dissolving and roughening the surface, and a method of chemically dissolving the surface selectively. As the mechanical method, usable is a method known in the art such as a ball grinding method, a brush grinding method, a blast grinding method, or a buff grinding method. As the electrochemical surface roughening method, there is a method wherein roughening is carried out in a hydrochloric or nitric acid electrolytic solution with alternating or direct current. Further, prior to surface roughening of the aluminum plate, if desired, in order to remove rolling oil on the surface, degreasing treatment is carried out, for example, using a surfactant, organic solvent, or alkaline aqueous solution.

Furthermore, preferable are those undercoated, after these treatments, with a water-soluble resin, a polymer or copolymer having polyvinyl phosphonic acid or a sulfonic acid group in its side chain, polyacrylic acid, a water-soluble metallic salt (e.g., zinc borate), a yellow dye, or an amine.

### [Ink-Jet Recording Method]

In the ink-jet plate making method of the present invention, a printing plate is formed by ejecting ink as droplets from an ink-jet recording head based on image information by an ink-jet printer loaded with a plate making ink, depositing onto a heated printing plate material, and evaporating and drying the ink solvent. Preferably in the method is curing same time by actinic energy ray radiation.

The ink-jet recording head used in the ink-jet plate making method of the present invention may be either an on-demand type or a continuous type. As the ejection method, there can be used any of the ejection methods including an electrical-mechanical conversion type (e.g., a single cavity type, a double cavity type, a vendor type, a piston type, a share mode type, and a shared-wall type) and an electrical-thermal conversion type (e.g., a thermal ink-jet type and a BUBBLE JET (a registered trademark) type).

The amount of ink droplets ejected from the head is preferably 0.5 picoliter or more to 7 picoliter or less, specifically preferably 0.8 picoliter or moere to 4 picoliter or less. When the amount of ink droplets is 0.5 picoliter or less, droplets having been ejected from the head are affected by air resistance and then stable jetting performance cannot be realized, resulting in decreased accuracy for a deposition position. When the amount of ink droplets is 7 picoliter or more, a single dot size will become excessively large, resulting in decreased resolution for a printing plate.

Further, it is possible that plural droplets are ejected from a single head via specially devised ejection, or are allowed to be deposited after the plural droplets, having continuously been ejected, are united during jetting.

Any types of ink jet printers are applicable to the present invention. To produce a printing plate resulting in high image quality, a flatbed type or a drum type is preferable. Further, preferable is a method wherein the printer of the present invention is built into a printing machine and then plate making is carried out thereon.

### [Heating of Printing Plate Material]

As a heating method of a printing plate material, it is preferable to incorporate in a transportation member to hold and transport a plate material for ink-jet printing: a heating means; a temperature measuring means; and a temperature control means. It is required to maintain the heating temperature at higher temperature than the minimum film forming temperature (MFT) of the resin particles in the solvent composition which constitutes the plate making ink. Although it is preferable to heat at 40° C. or more to 200° C. or less, it is more preferable to heat at 40° C. or more to 80° C.

### [Actinic Energy Ray Radiation and Irradiation Method]

The actinic energy ray radiation referred to in the present invention includes, for example, electron beams, UV radiation, α radiation, β radiation, γ radiation, and X-rays. Preferable are electron beams and UV radiation which have gained widespread industrial use, as well as featuring minimal hazard to the human body and easy handling.

When electron beams are employed, the amount of the irradiated electron beams is preferably in the range of 0.1 to 30 Mrad. When it is 0.1 Mrad or less, adequate irradiation effects cannot be realized. And when it is 30 Mrad or more, it is not preferable because it may deteriorate the support.

When UV radiation is employed, as a light source, there are used conventionally known ones such as a low pressure, medium pressure, or high pressure mercury lamp featuring an operation pressure of 0.1 kPa to 1 MPa, a metal halide lamp, a xenon lamp having an emission wavelength in the UV range, a cold-cathode tube, a hot-cathode tube, or an LED

### [Radiation Irradiation Conditions After Ink Deposition]

With regard to irradiation conditions of actinic energy ray radiation, actinic energy ray radiation is preferably irradiated 0.001 to 1.0 second, more preferably 0.001 to 0.5 second after ink deposition. To form highly detailed images, it is specifically crucial that the irradiation timing is as early as possible.

### (Lamp Setting)

As a UV irradiation method of actinic energy ray radiation, a basic method is disclosed in JP-A No. 60-132767. According to this method, a light source is placed on each of both sides of a head unit, and the head and the light sources are scanned via a shuttle method. Irradiation is carried out after the elapse of a predetermined period of time after ink deposition. Then, using another light source independent of driving, curing is completed. U.S. Pat. No. 6,145,979 discloses, as irradiation methods, an optical fiber method and a method wherein a collimated light source is directed to a mirror surface placed on the side of a head unit and then UV radiation is irradiated onto a recording section. In the image forming method of the present invention, any of these irradiation methods may be used.

Further, one of the preferred embodiments is also a method wherein irradiation of actinic energy ray radiation is divided into two steps: initially, actinic energy ray radiation is irradiated via the above method 0.001 to 2.0 seconds after ink deposition; and then actinic energy ray radiation is further irradiated.

### EXAMPLES

The present invention will now specifically be described with reference to examples, but the scope of the present invention is not limited solely to these examples. Herein, the expressions “parts” and “%” referred to in the examples represent “mass parts” and “mass %”, respectively, unless otherwise specified.

### Example 1

### <<Synthesis of Polymer 1>>

A reaction container was charged with 56 g of glycidyl methacrylate, 48 g of p-hydroxybenzaldeyde, 2 g of pyridine, and 1 g of N-nitroso-phenylhydroxyamine ammonium salt, then, the mixture was stirred for 8 hours in a water bath of 80° C.

Subsequently, 45 g of saponified polyvinyl acetate, having a polymerization degree of 300 and a saponification rate of 88%, was dispersed in 225 g of ion-exchanged water, and then 4.5 g of phosphoric acid and p-(3-methacryloxy-2-hydroxypropyloxy)benzaldehyde, having been prepared via the above reaction, were added to the resulting solution in such a manner that the modification rate was allowed to be 3 mol % based on polyvinyl alcohol, then, the mixture was stirred at 90° C. for 6 hours. The thus-prepared solution was cooled to room temperature, and 30 g of a basic ion-exchange resin was added, followed by being stirred for 1 hour. Then, the ion-exchange resin was filtered, and IRUGACURE 2959 (produced by Ciba Specialty Chemicals, Ltd.) was blended, as a photopolymerization initiator, at a ratio of 0.1 g based on 100 g of a 15% aqueous solution, followed by diluted with ion-exchanged water to give a 10% aqueous solution of Polymer 1.

### <<Preparation of Image Forming Ink>>

(Preparation of Ink 1)

| | |
|---|---|
| 10% aqueous solution of Polymer 1 | 3 mass parts |
| | (as solid portion) |
| Resin particles (Joncryl 780, made by | 5 mass parts |
| BASF Co., MFT (water): 89° C., | (as solid portion) |
| acid value: 46 mg KOH/g) | |
| PG (Propylene glycol, boiling point: 187° C.) | 40 mass parts |
| Cyan pigment dispersion (Cab-o-jet 250C, | 6 mass parts |
| made by Cabot Co.) | |

Ion-exchanged water was added to the above additives to give a total amount of 100 mass parts.

Subsequently, filtration was carried out using a #3500 mesh metal filter, followed by degassing with a hollow fiber module to prepare Ink 1.

### (Preparation of Inks 2 to 25)

Inks 2 to 25 were prepared in the same manner as in preparation of Ink 1 except that the type of resin particles, the type of water-soluble organic solvent, and presence or non-presence of Polymer 1 were changed as listed in Table 2.

In addition, the details of the resin particles and water-soluble organic solvents listed in an abbreviated name in Table 2 are as follows.

### <Resin Particles>

J780: Joncryl 780, made by BASF Co., MFT (water): 89° C., acid value: 46 mg KOH/g)
J790: Joncryl 790, made by BASF Co., MFT (water): 67° C., acid value: 30 mg KOH/g)
SX 8900C: made by JSR Co., Ltd., MFT (water): 53° C.
PDX-7145: made by BASF Co., MFT (water): 25° C., acid value: 32 mg KOH/g
NM972:Nichigo-Mowinyl 972, made by Japanese Synthetic Chemistry Co., Ltd., MFT (water): 105° C., acid value: 2 mg KOH/g

### <Water-Soluble Organic Solvent>

PG: Propylene glycol
DMSO: Dimethyl sulfoxide
DPG: Dipropylene glycol
2-PD: 2-Pyridinone
TEG: Triethylene glycol
EG: Ethylene glycol
1,4-BD: 1,4-butanediol
Gly: Glycerin
Solv 1: DMSO/EG=80/20
Solv 2: DMSO/EG=50/50
Solv 3: DMSO/EG=20/80
Solv 4: DMSO/EG=10/90

### <<Production of Printing Plate>>

### (Ink-Jet Printer)

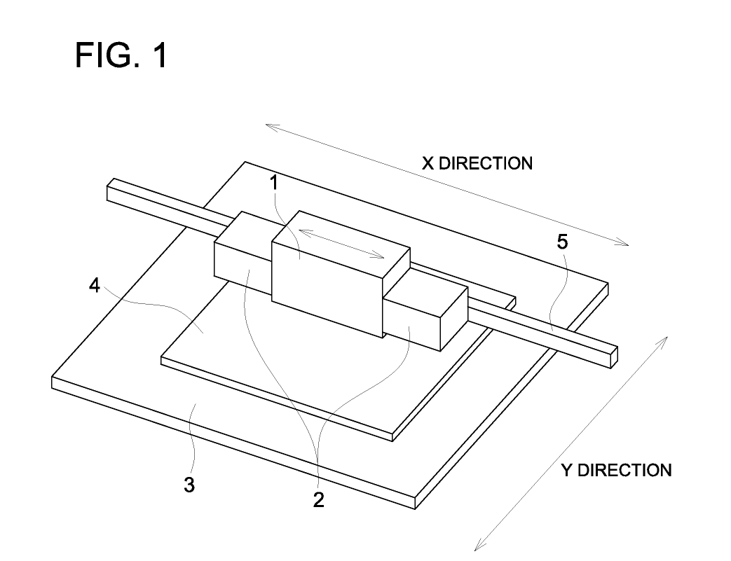

The ink-jet printer shown in FIG. 1 was employed. The printer is a flatbed-type ink-jet printer wherein a piezo-type ink-jet head, with 512 nozzles, featuring a nozzle diameter of 20 μm and a nozzle resolution of 300 dpi (“dpi” referred to in the present invention represents the number of dots per 2.54 cm), is mounted on carriage 1, and UV irradiation source 2 is placed on each of both sides of carriage 1. These are installed on a carriage transportation guide 5 in the ink-jet printer. Carriage 1 moves in the X direction of FIG. 1. A grained aluminium plate material is held by a transportation unit 3. By moving the moving transportation unit 3 in the Y direction, total surface of the printing plate was scanned.

Further, the transportation unit 3 is equipped with a heating means (not illustrated), a temperature measuring means to measure the temperature of the printing plate (not illustrated) and a temperature controlling means (not illustrated). Thereby it is possible to maintain the printing plate at a constant temperature.

In the present example, there were prepared two samples: of heated at 60 C the temperature of the printing plate of one sample was heated at 60° C.; and the temperature of the printing plate of the other sample was kept at room temperature of 25° C. without being heated.

### (Production of Printing Plates 1 to 27)

An image having a resolution of 1400 dpi×1400 dpi was formed on a grained aluminum substrate serving as a plate material with a droplet amount of 1 picoliter of each ink. For the purpose of visual evaluation, the image was prepared by combination of a solid image of 10 cm×10 cm, a fine line image, 3-point to 10-point Mincho typeface character images, and an image composed of a natural image (a photograph).

Light exposure was done under the condition of 120 W/cm via irradiation of a metal halide lamp (MAL 400NL with a supply power of 3 kW·hr, produced by Japan Storage Battery Co., Ltd.) placed on each of both sides of the carriage.

The transportation speed of the carriage was set at 400 mm/sec.

Since each of the inks differs in viscosity, a voltage applied to the piezo elements of the printer was controlled so that the droplet amount of each ink became 1 picoliter.

Printing plates 1 to 27 each were prepared by setting the type of the ink, the heating condition of the printing plate material and the light exposure condition as described in Table 2.

### <<Evaluation of Printing Plate Images>>

### [Evaluation of Liquid Gathering Resistance 1]

With respect to each image produced by the above-described image forming method, mainly the image of a natural image was focused. Visual observation of the existence of mottled appearance was carried out, and the liquid gathering resistance 1 was evaluated in accordance with the following criteria.

A: No mottle is observed.

B: Very slight mottle is observed.

C: Although weak mottle is observed in a certain potion of the image, but it is in a tolerable level practically.

D: Strong mottle is observed to some extent.

E. Very Strong mottle is observed in all portions of the image, and it cannot be applicable to practical use.

### (Evaluation of Printing Durability)

A printing plate produced was mounted on a printing machine, and printing was carved out on a coated paper (OK produced by Hokuetsu Paper Co., Ltd.) in an amount of 20,000 sheets. Each time after printing 1,000 sheets, one sheet of print was taken and lack in the fine line portion and lack or crush of the character on the thus-printed paper were observed using a magnifier. The number of sheets which began to generate the defect was recorded.

The evaluation results thus obtained are shown in Table 2.

Based on the following criteria, printing durability was evaluated.

TABLE 2

| | | | | | Water-soluble | | | | | | | | |
|---|---|---|---|---|---|---|---|---|---|---|---|---|---|
| | | Resin particles | | | organic solvent | | Resin | | | Light | Evaluation result | | |
| | | | | Acid | | Boiling | particles | | Heating of | exposure | | Liquid | |
| Printing | Ink | Kind of | MFT | Value | Kind of | point | MFT | | printing | (Yes or | Printing | gathering | Re- |
| plate No. | No. | material | (water) | (*1) | solvent | (° C.) | (in Ink) | Polymer 1 | plate (° C.) | None) | durability | resistance 1 | marks |
| 1 | 1 | J780 | 89 | 46 | PG | 187 | 45 | Yes | 60 | Yes | >20000 | A | Inv. |
| 2 | 2 | J780 | 89 | 46 | DMSO | 189 | 45 | Yes | 60 | Yes | >20000 | A | Inv. |
| 3 | 3 | J780 | 89 | 46 | DPG | 232 | 52 | Yes | 60 | Yes | 20000 | A | Inv. |
| 4 | 4 | J780 | 89 | 46 | 2-PD | 245 | 45 | Yes | 60 | Yes | 20000 | A | Inv. |
| 5 | 5 | J780 | 89 | 46 | TEG | 287 | 55 | Yes | 60 | Yes | 18000 | A | Inv. |
| 6 | 6 | J780 | 89 | 46 | EG | 197 | 88 | Yes | 60 | Yes | 5000 | A | Comp. |
| 7 | 7 | J780 | 89 | 46 | 1,4-BD | 229 | 87 | Yes | 60 | Yes | 5000 | A | Comp. |
| 8 | 8 | J780 | 89 | 46 | Gly | 290 | 88 | Yes | 60 | Yes | 5000 | A | Comp. |
| 9 | 9 | J790 | 67 | 30 | DMSO | 189 | <20 | Yes | 60 | Yes | 18000 | A | Inv. |
| 10 | 10 | J790 | 67 | 30 | EG | 197 | 64 | Yes | 60 | Yes | 8000 | A | Comp. |
| 11 | 11 | SX8900C | 53 | — | DMSO | 189 | <20 | Yes | 60 | Yes | 18000 | A | Inv. |
| 12 | 12 | SX8900C | 53 | — | EG | 197 | 50 | Yes | 60 | Yes | 8000 | A | Comp. |
| 13 | 13 | PDX-7145 | 25 | 32 | DMSO | 189 | <20 | Yes | 60 | Yes | 8000 | A | Comp. |
| 14 | 14 | PDX-7145 | 25 | 32 | EG | 197 | 25 | Yes | 60 | Yes | 8000 | A | Comp. |
| 15 | 15 | J780 | 89 | 46 | DMSO | 189 | 45 | — | 60 | None | 20000 | A | Inv. |
| 16 | 16 | J780 | 89 | 46 | EG | 197 | 86 | — | 60 | None | 5000 | A | Comp. |
| 17 | 2 | J780 | 89 | 46 | DMSO | 189 | 45 | Yes | None | Yes | 1000 | E | Comp. |
| 18 | 15 | J780 | 89 | 46 | DMSO | 189 | 45 | — | None | None | 1000 | E | Comp. |
| 19 | 17 | J780 | 89 | 46 | Solv1 | 191 | 50 | — | 60 | None | 20000 | A | Inv. |
| 20 | 18 | J780 | 89 | 46 | Solv2 | 193 | 55 | — | 60 | None | 18000 | A | Inv. |
| 21 | 19 | J780 | 89 | 46 | Solv3 | 195 | 75 | — | 60 | None | 10000 | A | Inv. |
| 22 | 20 | J780 | 89 | 46 | Solv4 | 196 | 86 | — | 60 | None | 8000 | A | Comp. |
| 23 | 21 | NM972 | 105 | 2 | PG | 187 | 40 | Yes | 60 | Yes | 18000 | B | Inv. |
| 24 | 22 | NM972 | 105 | 2 | DMSO | 189 | 55 | Yes | 60 | Yes | 18000 | B | Inv. |
| 25 | 23 | NM972 | 105 | 2 | DPG | 232 | 50 | Yes | 60 | Yes | 8000 | B | Inv. |
| 26 | 24 | NM972 | 105 | 2 | 2-PD | 245 | 45 | Yes | 60 | Yes | 8000 | B | Inv. |
| 27 | 25 | NM972 | 105 | 2 | TEG | 287 | 50 | Yes | 60 | Yes | 8000 | B | Inv. |

*1: mgKOH/g,
Inv.: Invention,
Comp.: Comparison

It was shown that the image formed using the ink-jet plate making method of the present invention was excellent in liquid gathering resistance and printing durability.

### Example 2

### <<Exchange of Counter Salt of Resin Particles>>

Commercially available resin particles J780 (Joncryl 780, made by BASF Co., MFT (water): 89° C., acid value: 46 mg KOH/g), J631 ((Joncryl 631, made by BASF Co., MFT (water): 80° C., acid value: 25 mg KOH/g), NM972 (Nichigo-Mowinyl 972, made by Japanese synthetic-chemistry Co., Ltd., MFT (water): 105° C., acid value: 2 mg KOH/g) each were diluted with ion-exchanged water so that the solid portion became 10%. Then, desalt purification was performed using a small type pump unit of Membrane Master RUM-2 and a thin layer flow flat membrane test cell of Membrane Master C10-T (made by Nitto Denko Co., Ltd.). At this moment, the counter salt was substituted by an amine salt and an alkali metal by adding respectively suitably excessive amounts of an aqueous ammonia solution or alkali metal chloride and ion exchange water. Desalting purification was performed for a sufficient time after adding ammonia or an alkali metal chloride, and each resin particle solution in which the counter salt was substituted with an amine salt or an alkali metal was finally obtained.

### <<Preparation of Image Forming Ink>>

(Preparation of Ink 26)

| | |
|---|---|
| 10% aqueous solution of Polymer 1 | 3 mass parts |
| (described in Example 1) | (as solid portion) |
| Resin particles (Joncryl 780, made by | 5 mass parts |
| BASF Co., MFT (water): 89° C., | (as solid portion) |
| acid value: 46 mg KOH/g, counter salt: NH₃) | |
| PG (Propylene glycol, boiling point: 187° C.) | 40 mass parts |
| Cyan pigment dispersion (Cab-o-jet 250C, | 6 mass parts |
| made by Cabot Co.) | |

Ion-exchanged water was added to the above the above additives to give a total amount of 100 mass parts.

Subsequently, filtration was carried out using a #3500 mesh metal filter, followed by degassing with a hollow fiber module to prepare Ink 26.

### (Preparation of Inks 27 to 43)

Inks 27 to 43 were prepared in the same manner as in preparation of Ink 26 except that the type of resin particles and counter salt, and the type of water-soluble organic solvent were changed as listed in Table 3.

### <<Production of Printing Plate>>

### (Ink-Jet Printer)

The ink-jet printer shown in FIG. 1 was employed. The printer is a flatbed-type ink-jet printer wherein a piezo-type ink-jet head, with 512 nozzles, featuring a nozzle diameter of 20 μm and a nozzle resolution of 300 dpi (“dpi” referred to in the present invention represents the number of dots per 2.54 cm), is mounted on carriage 1, and UV irradiation source 2 is placed on each of both sides of carriage 1. These are installed on a carriage transportation guide 5 in the ink-jet printer. Carriage 1 moves in the X direction of FIG. 1. A grained aluminium plate material is held by a transportation unit 3. By moving the moving transportation unit 3 in the Y direction, total surface of the printing plate was scanned.

Further, the transportation unit 3 is equipped with a heating means (not illustrated), a temperature measuring means to measure the temperature of the printing plate (not illustrated) and a temperature controlling means (not illustrated). Thereby it is possible to maintain the printing plate at a constant temperature.

The temperature of the printing plate was heated at 60° C.

### (Production of Printing Plates 28 to 45)

An image having a resolution of 1400 dpi×1400 dpi was formed on a grained aluminum substrate serving as a plate material with a droplet amount of 1 picoliter of each ink. For the purpose of visual evaluation, the image was prepared by combination of a solid image of 10 cm×10 cm, a fine line image, 3-point to 10-point Mincho typeface character images, and an image composed of a natural image (a photograph).

Irradiation of actinic energy rays was done under the condition of 120 W/cm via irradiation of a metal halide lamp (MAL 400NL with a supply power of 3 kW·hr, produced by Japan Storage Battery Co., Ltd.) placed on each of both sides of the carriage.

The transportation speed of the carriage was set at 700 mm/see, and the inks listed in Table 3 were used to prepare Printing plates 28 to 45 and the following evaluations were done.

Since viscosity differed in each ink, the voltage added to the piezo element of a printer was adjusted so that the amount of droplet of each ink may become 1 picoliter.

### <<Evaluation of Printing Plate Images>>

Evaluation of printing durability was performed in the same mariner as described in Example 1, and evaluation of the liquid gathering resistance 2 was performed in accordance with the following criteria.

### [Evaluation of Liquid Gathering Resistance 2]

A solid image was prepared under the condition of the above-described 700 mm/sec. Visual observation of the existence of mottled appearance was carried out, and the liquid gathering resistance 2 was evaluated in accordance with the following criteria.

A: No mottle is observed.

B: Very slight mottle is observed.

C: Although weak mottle is observed in a certain potion of the image, but it is in a tolerable level practically.

D: Strong mottle is observed to some extent.

E. Very Strong mottle is observed in all portions of the image, and it cannot be applicable to practical use.

TABLE 3

| | | | | | | Water-soluble | | | | Heating | | | | |
|---|---|---|---|---|---|---|---|---|---|---|---|---|---|---|
| | | Resin particles | | | | organic solvent | | Resin | | of | Light | Evaluation result | | |
| Printing | | | | Acid | | | Boiling | particles | | printing | exposure | | Liquid | |
| plate | Ink | Kind of | MFT | value | Counter | Kind of | point | MFT | Polymer | plate | (Yes or | Printing | gathering | Re- |
| No. | No. | material | (water) | (*1) | salt | solvent | (° C.) | (in ink) | 1 | (° C.) | None) | durability | resistance 2 | marks |
| 28 | 26 | J780 | 89 | 46 | NH₃ | PG | 187 | 45 | Yes | 60 | Yes | >20000 | B | Inv. |
| 29 | 27 | J780 | 89 | 46 | NH₃ | DPG | 232 | 52 | Yes | 60 | Yes | 20000 | B | Inv. |
| 30 | 28 | J780 | 89 | 46 | NH₃ | EG | 197 | 88 | Yes | 60 | Yes | 5000 | C | Comp. |
| 31 | 29 | J631 | 80 | 25 | NH₃ | PG | 187 | 40 | Yes | 60 | Yes | >20000 | B | Inv. |
| 32 | 30 | J631 | 80 | 25 | NH₃ | DPG | 232 | 47 | Yes | 60 | Yes | 20000 | B | Inv. |
| 33 | 31 | J631 | 80 | 25 | NH₃ | EG | 197 | 78 | Yes | 60 | Yes | 5000 | D | Comp. |
| 34 | 32 | NM972 | 105 | 2 | NH₃ | PG | 187 | 40 | Yes | 60 | Yes | 18000 | C | Inv. |
| 35 | 33 | NM972 | 105 | 2 | NH₃ | DPG | 232 | 50 | Yes | 60 | Yes | 8000 | C | Inv. |
| 36 | 34 | NM972 | 105 | 2 | NH₃ | EG | 232 | 102 | Yes | 60 | Yes | 1000 | D | Comp. |
| 37 | 35 | J780 | 89 | 46 | Na | PG | 187 | 45 | Yes | 60 | Yes | >20000 | A | Inv. |
| 38 | 36 | J780 | 89 | 46 | Na | DPG | 232 | 52 | Yes | 60 | Yes | 20000 | A | Inv. |
| 39 | 37 | J780 | 89 | 46 | Na | EG | 197 | 88 | Yes | 60 | Yes | 5000 | C | Comp. |
| 40 | 38 | J631 | 80 | 25 | Na | PG | 187 | 40 | Yes | 60 | Yes | >20000 | A | Inv. |
| 41 | 39 | J631 | 80 | 25 | Na | DPG | 232 | 47 | Yes | 60 | Yes | 20000 | A | Inv. |
| 42 | 40 | J631 | 80 | 25 | Na | EG | 197 | 78 | Yes | 60 | Yes | 5000 | D | Comp. |
| 43 | 41 | NM972 | 105 | 2 | Na | PG | 187 | 40 | Yes | 60 | Yes | 18000 | B | Inv. |
| 44 | 42 | NM972 | 105 | 2 | Na | DPG | 232 | 50 | Yes | 60 | Yes | 8000 | B | Inv. |
| 45 | 43 | NM972 | 105 | 2 | Na | EG | 232 | 102 | Yes | 60 | Yes | 1000 | D | Comp. |

*1: mgKOH/g,
Inv.: Invention,
Comp.: Comparison

As is clearly shown by the results listed in Table 3, it was demonstrated that the image formed in accordance with the ink-jet plate making method of the present invention was excellent in liquid gathering resistance and printing durability. Especially, as a counter salt of the resin particles, it was demonstrated that the sodium salt exhibited excellent effects compared with the amine salt.

### Description of Symbols

1: carriage

2: UV irradiation source

3: transportation unit

4: aluminium plate material

5: carriage transportation guide

1. An ink-jet plate making method comprising the steps of:
using a plate making ink containing at least water, one or more water-soluble organic solvents and resin particles,
adhering the plate making ink on a heated printing plate material, and
volatilizing the solvents in the jetted plate making ink to dry the ink and thereby form an image,
wherein the resin particles exhibit a minimum film-forming temperature in water (MFT (water)) of 40° C. or more, and the plate making ink contains a water-soluble organic solvent (A) which enables to decrease the MFT of the resin particles by 5° C. or more, the water-soluble organic solvent (A) is contained in an amount of 20% or more of all the water-soluble organic solvents, and the water-soluble organic solvent (A) has a boiling point of 180° C. or more to 300° C. or less.

2. The ink-jet plate making method of claim 1,
wherein the water-soluble organic solvent (A) is contained in an amount of 80% or more based on the total mass of the water-soluble organic solvents.

3. The ink-jet plate making method of claim 1,
wherein the water-soluble organic solvent (A) has a boiling point of 180° C. or more to 250° C. or less.

4. The ink-jet plate making method of claim 1,
wherein the water-soluble organic solvent (A) has a boiling point of 180° C. or more to 200° C. or less.

5. The ink-jet plate making method of claim 1,
wherein the resin particles have an acid value of 10 mg KOH/g or more.

6. The ink-jet plate making method of claim 1,
wherein the resin particles have an acid value of 30 mg KOH/g or more.

7. The ink-jet plate making method of claim 1,
wherein the resin particles contain an alkali metal salt as a counter salt of an acid.

8. The ink-jet plate making method of claim 1,
wherein the alkali metal salt is a sodium salt.

9. The ink-jet plate making method of claim 1,
wherein the plate making ink contains a polymer having a main chain with a plurality of side chains among which cross-linking can be induced by irradiation with actinic energy rays, the polymer is contained in an amount of 0.8 mass % to 5.0 mass % or more based on the total mass of the ink, the main chain of the polymer is a saponified compound of poly vinyl acetate, the degree of saponification is 77% or more to 99% or less, and the degree of polymerization is 200 or more to 4,000 or less.

10. The ink-jet plate making method of claim 1,
wherein the image is formed by irradiation with actinic energy rays after adhering the plate making ink on the printing plate material.

11. The ink-jet plate making method of claim 2,
wherein the water-soluble organic solvent (A) has a boiling point of 180° C. to 200° C., and the resin particles have an acid value of 10 mg KOH/g or more.

12. The ink-jet plate making method of claim 11,
wherein the resin particles contain an alkali metal salt as a counter salt of an acid.

13. The ink-jet plate making method of claim 9,
wherein the water-soluble organic solvent (A) is contained in an amount of 80% or more based on the total weight of the water-soluble organic solvents, the water-soluble organic solvent (A) has a boiling point of 180° C. to 200° C., and the resin particles have an acid value of 30 mg KOH/g or more.

14. The ink-jet plate making method of claim 13,
wherein the resin particles contain an alkali metal salt as a counter salt of an acid.

15. The ink-jet plate making method of claim 3,
wherein the resin particles have an acid value of 10 mg KOH/g or more, and the resin particles contain an alkali metal salt as a counter salt of an acid.

16. The ink-jet plate making method of claim 10,
wherein the water-soluble organic solvent (A) has a boiling point of 180° C. to 250° C., the resin particles have an acid value of 10 mg KOH/g or more, and the resin particles contain an alkali metal salt as a counter salt of an acid.

17. The ink-jet plate making method of claim 1,
wherein an average particle diameter of the resin particles contained in the plate making ink is 5 to 150 nm.

18. The ink-jet plate making method of claim 1,
wherein an amount of the resin particles contained in the plate making ink is 0.1 to 7 weight % based on the total weight of the plate making ink.
